(19) United States
(12) Patent Application Publication
(10) Pub. No.: US 2006/0219488 A1
(43) Pub. Date: Oct. 5, 2006

(54) Disc brake hub adapter structure

(76) Inventor: Chun-Hsung Chen, Taichung County (TW)

Correspondence Address: BIRCH STEWART KOLASCH & BIRCH, PO BOX 747, FALLS CHURCH, VA, 22040-0747, US

(21) Appl. No.: 11/091,365

(22) Filed: Mar. 29, 2005

(51) Int. Cl. B62L 5/00

(52) U.S. Cl. 188/26

(57) ABSTRACT

The present invention discloses a disc brake hub adapter structure, which is a hollow cylinder having a plum blossom shaped wavy thread on its internal periphery to be engaged with an axle having a corresponding shape with the hub, and a plurality of embedding teeth disposed around the corner folding position is disposed at the internal side of the axle of the hub and engaged with a plurality of concave teeth around the internal side of the adapter, wherein the adapter has a connecting section extended outward from a side ring at the external periphery of the adapter. The connecting section has a plurality of holes for receiving a connecting device and connecting a brake disc with a plum blossom shaped center hole.

### FIELD OF THE INVENTION

The present invention relates to an adapter of a bicycle hub that connects a brake disc and a hub, such that the special space configuration of the adapter can connect the hub with a center hole of a plum blossom shaped brake disc.

### BACKGROUND OF THE INVENTION

Referring to FIGS. 1 and 2 for a prior art bicycle hub adapter structure, the adapter structure includes a hollow cylindrical hub 1, a plurality of latch teeth 2 around the corner folding position along a lateral wall of the hub 1 and the axial wall of the hub 1, a slot 3 formed between two latch teeth 2, a plurality of spokes for connecting the external periphery of the hub 1 with a tire (not shown in the figure), an adapter 4 passing sideway through the external side of the hub 1, a plurality of protruded embedding teeth 5 disposed around the internal side of the adapter 4, and a concave tooth 6 disposed between two embedding teeth 5, such that an opening at the internal side of the adapter 4 can be engaged with the latch teeth 2 and the slot 3 on the external wall of the hub 1, and the external side of the adapter is connected with the bicycle spindle by a securing ring 7 and fixed into a screw hole 8 of the hub 1. When a bicycle is braked, a brake disc 9 can stop the rotation of the adapter 4, and thus stopping the hub 1 from being rotated because the adapter 4 is engaged with the hub 1 and thus achieving the brake function. As we know that if a brake is applied for an emergency situation in a high-speed ride, the disc brake 9 will be stopped suddenly and a very large torque will be exerted instantly between the adapter 4 and the embedding teeth 5. More particularly, when each latch tooth 2 at the external side of the hub 1 and the protruded embedding teeth 5 of the adapter 4 are protruded outward with a 90-degree angle, and the corner folding position will be cracked or broken easily, and thus causing each braked latch tooth 2 of the hub 1 to be cracked or broken easily. Furthermore, the adapter 4 of this sort cannot be installed into the center hole of a plum blossom shaped brake disk.

### SUMMARY OF THE INVENTION

The primary objective of the present invention is to provide a disc brake hub adapter structure, which is a hollow cylinder having a plum blossom shaped wavy thread on its internal periphery to be engaged with an axle having a corresponding shape with the hub, and a plurality of embedding teeth disposed around the corner folding position is disposed at the internal side of the axle of the hub and engaged with a plurality of concave teeth around the internal side of the adapter; wherein the adapter has a connecting section extended outward from a side ring at the external periphery of the adapter. The connecting section has a plurality of holes for receiving a connecting device and connecting a brake disc with a plum blossom shaped center hole.

### BRIEF DESCRIPTION OF THE DRAWINGS

FIG. 1 is an exploded view of a prior art bicycle hub adapter;

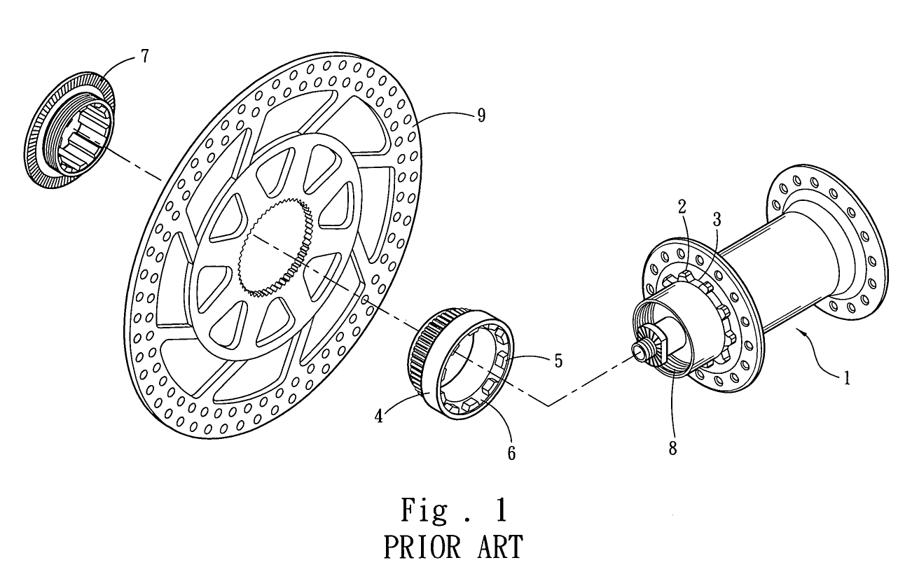

FIG. 2 is a cross-sectional view of a prior art bicycle hub adapter;

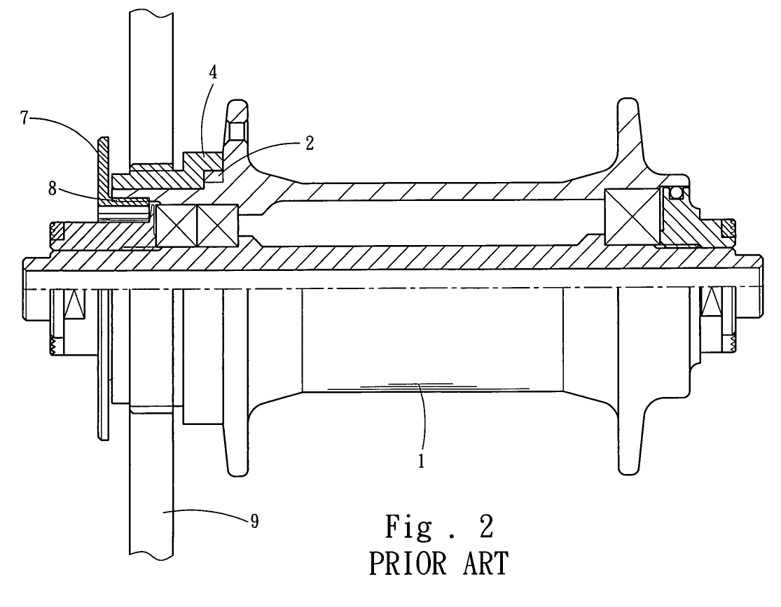

FIG. 3 is an exploded view of a preferred embodiment of the present invention; and

FIG. 4 is a cross-sectional view of an assembly of a preferred embodiment of the present invention.

### DETAILED DESCRIPTION OF THE PREFERRED EMBODIMENTS

To make it easier for our examiner to understand the objective of the invention, its structure, innovative features, and performance, we use a preferred embodiment and the attached drawings for the detailed description of the invention.

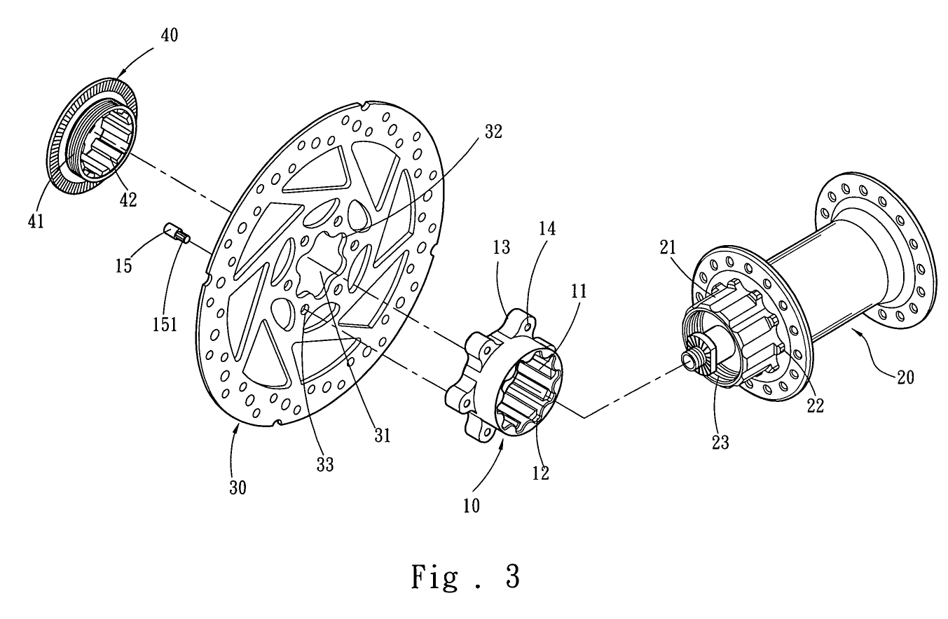

Referring to FIG. 3, a disc brake hub adapter structure in accordance with the present invention comprises: a hollow cylinder 10; a hub 20 coupled on its internal side; a brake disc 30 installed on its external side; a plum blossom shaped wavy thread disposed on a wall surface of an internal periphery of the cylinder 10 and engaged with the corresponding shape of an axle 21 of the hub 20; a plurality of concave teeth 12 disposed around the internal periphery of the cylinder 10 at a position proximate to a side of the hub 20 and coupled onto the embedding teeth 5 on the internal side of the axle 21 of the hub 20; a connecting section extended circularly from the external wall of the cylinder 10, and the connecting section is comprised of six ears 13 arranged in a circular shape and each ear 13 has a hole at its center for receiving a connecting device such as an insert pin 15, and the insert pin 15 has a pressed thread 151 at its end section.

The center hole 31 of the brake disc 30 is a plum blossom shaped scraggy ring hole. A connecting hole 33 is disposed between two outwardly protruded arc edges 32, and each connecting hole 33 is provided for receiving a forced insertion of the insert pin 15, such that the pressed thread 151 can be latched into the connecting hole 33 and the brake disc 30 is secured onto the cylinder 10.

A securing member 40 is disposed at an external side of the brake disc 30, which is a hollow cover member having an external threaded pipe 41 coupled to the internal threaded hole 23 on the axle 21 of the hub 20, and the securing member 40 has a plurality of wavy teeth 42 disposed around the internal periphery of the securing member 40, and the wavy teeth 42 can be turned by a removing tool with a corresponding shape (not shown in the figure), so that the securing member 40 can fix the brake disc 30 onto the hub 20 again to prevent it from falling off due to the vibrations.

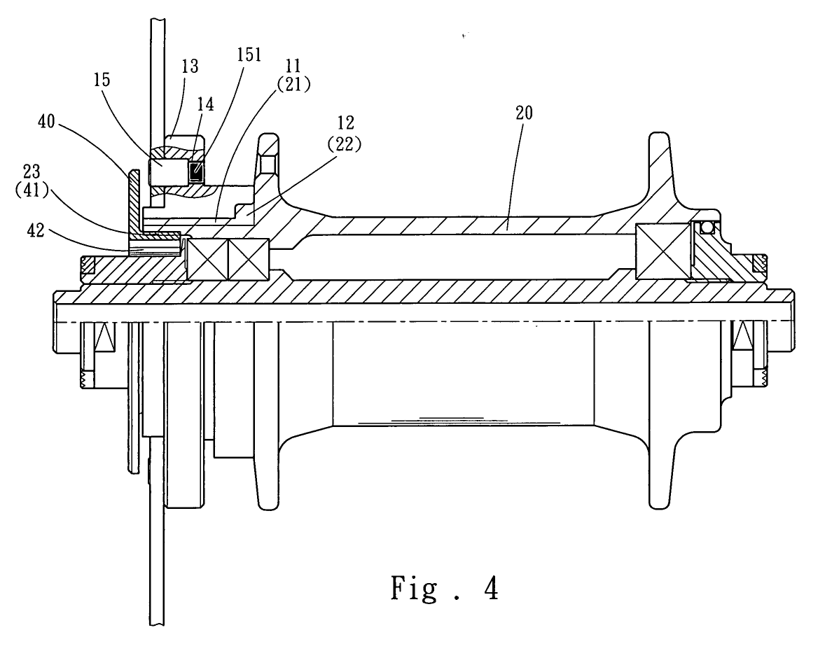

Referring to FIG. 4, the adapter of the present invention and the hub 20 are engaged, and the plum blossom shaped wavy thread at the internal periphery of the cylinder 10 is engaged with the corresponding shape of the axle 21, and the concave teeth 21 disposed around the internal side of the cylinder 10 can be engaged with the embedding teeth 5 at the corner folding position of the axle 21 of the hub 20, so that the area for the cylinder 20 being engaged with the hub 20 is increased to improve the braking force of the adapter for stopping the rotation of the hub 20 and strengthen the resistance to the force exerted at the turning corners of the axle 21 of the hub, so as to prevent possible cracks.

It is noteworthy that the cylinder 10 of the invention has a plurality of ears 13 disposed around the external side of the cylinder 10, and each ear 13 has a hole 14 at its center for connecting the connecting hole 33 of the brake disc 30 and receiving the insertion of an insert pin 15, such that the pressed thread 151 at the end section of the insert pin 15 is latched into the connecting hole 33 of the brake disc 30. If the bike is braked, the adapter on the brake disc 30 stops the rotation of the hub 20, and a securing member 40 is installed at the external side of the brake disc 30 and disposed in the axle 21 of the hub 20, which can prevent the brake disc 30 from falling off and provide a safety measure for the brake disc 30.

In summation of the above description, the present invention herein enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A disc brake hub adapter structure, being a hollow cylinder and having a plum blossom shaped wavy thread on its internal periphery to be engaged with an axle having a corresponding shape with a hub, and a plurality of embedding teeth disposed around the corner folding position is disposed at the internal side of said axle of said hub and engaged with a plurality of concave teeth around the internal side of an adapter, wherein said adapter has a connecting section extended outwardly from a side ring at the external periphery of said adapter, and said connecting section has a plurality of holes for receiving a connecting device and connecting a brake disc.

2. The disc brake hub adapter structure of claim 1, wherein said connecting section comprises a plurality of outwardly protruded ears disposed in a circular form and having a height less than a height of said adapter, said each ear has a hole at its center, said connecting device is an insert pin, and said insert pin has a pressed thread at an end section to be forced into a connecting hole of said brake disc.

3. The disc brake hub adapter structure of claim 1, wherein said brake disc has a center hole disposed at its center, and said center hole being a plum blossom shaped scraggy ring hole, and a connecting hole disposed between two outwardly protruded arc edges.

4. The disc brake hub adapter structure of claim 1, further comprising a securing member having an external threaded pipe coupled with an internal threaded hole of said axle, the securing member having a plurality of wavy teeth disposed around an internal periphery thereof.

5. The disc brake hub adapter structure of claim 4, wherein the wavy teeth are turned by a removing tool having a corresponding shape.

6. The disc brake hub adapter structure of claim 1, wherein the plum blossom shaped wavy thread engages tightly with the axle having a corresponding shape.

7. The disc brake hub adapter structure of claim 1, wherein the plum blossom shaped wavy thread engages tightly with the axle having a corresponding shape.
